(19) United States
(12) Patent Application Publication
(10) Pub. No.: US 2012/0278267 A1
(43) Pub. Date: Nov. 1, 2012

(54) METHODS AND ARRANGEMENTS FOR DYNAMICALLY GENERATING ESTIMATION TRENDLINES

(75) Inventors: Nanjangud C. Narendra, Bangalore (IN); Karthikeyan Ponnalagu, Nadu (IN); Renuka Sindhgatta Rajan, Bangalore (IN); Nianjun Zhou, Danbury, CT (US)

(73) Assignee: INTERNATIONAL BUSINESS MACHINES CORPORATION, Armonk, NY (US)

(21) Appl. No.: 13/095,484

(22) Filed: Apr. 27, 2011

(51) Int. Cl. G06N 5/02

(52) U.S. Cl. 706/46

(57) ABSTRACT

Methods and arrangements for dynamic trendline generation. Input data are assimilated at a capture timepoint from an estimation tool. The input data are filtered, and an estimation-centric map is created from the filtered data ; this creating of a map includes generating an estimation data tree. A trendline is dynamically generated responsive to a request, wherein this generating of a trendline includes applying the estimation data tree to the input data. The dynamically generated trendline is supplied to the estimation tool.

### BACKGROUND

Software development effort estimation involves a process of predicting the effort required to develop software based on incomplete, uncertain and/or noisy input. As such, several different types of estimation have been used conventionally. A formal estimation model is based on the use of a formula derived from historical data, while expert estimation involves subjective judgment Generally, expert estimation has emerged as a dominant strategy when estimating software development effort

It has often been found that effort estimates are overly and unduly optimistic, with a considerable degree of overconfidence invested in their accuracy. Formal software effort estimation models have conventionally not been found to be reliable over time, especially to the extent that they do not draw on a given organization's own context. In other words, in the absence of any historical data collected and gleaned from more immediate experience, there is a tendency to employ industry-wide data that may not at all be relevant to a current context. Significant disadvantages then arise, such as an inability to extract specific insights from raw data and permit transparency in trend line generation.

### BRIEF SUMMARY

In summary, one aspect of the invention provides a method comprising: assimilating input data at a capture timepoint from an estimation tool; filtering the input data; creating an estimation-centric map from the filtered data; the creating comprising generating an estimation data tree; dynamically generating a trendline responsive to a request; the generating comprising applying the estimation data tree to the input data; and supplying the dynamically generated trendline to the estimation tool.

Another aspect of the invention provides an apparatus comprising: at least one processor; and a computer readable storage medium having computer readable program code embodied therewith and executable by the at least one processor, the computer readable program code comprising: computer readable program code configured to assimilate input data at a capture timepoint from an estimation tool; computer readable program code configured to filter the input data; computer readable program code configured to create an estimation-centric map from the filtered data; computer readable program code configured to generate an estimation data tree; computer readable program code configured to dynamically generate a trendline responsive to a request; computer readable program code configured to apply the estimation data tree to the input data; and computer readable program code configured to supply the dynamically generated trendline to the estimation tool.

An additional aspect of the invention provides a computer program product comprising: a computer readable storage medium having computer readable program code embodied therewith, the computer readable program code comprising: computer readable program code configured to assimilate input data at a capture timepoint from an estimation tool; computer readable program code configured to filter the input data; computer readable program code configured to create an estimation-centric map from the filtered data; computer readable program code configured to generate an estimation data tree; computer readable program code configured to dynamically generate a trendline responsive to a request; computer readable program code configured to apply the estimation data tree to the input data; and computer readable program code configured to supply the dynamically generated trendline to the estimation tool.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates an arrangement for data assimilation and trendline generation.

FIG. 3 sets forth a process more generally for dynamic trendline generation.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

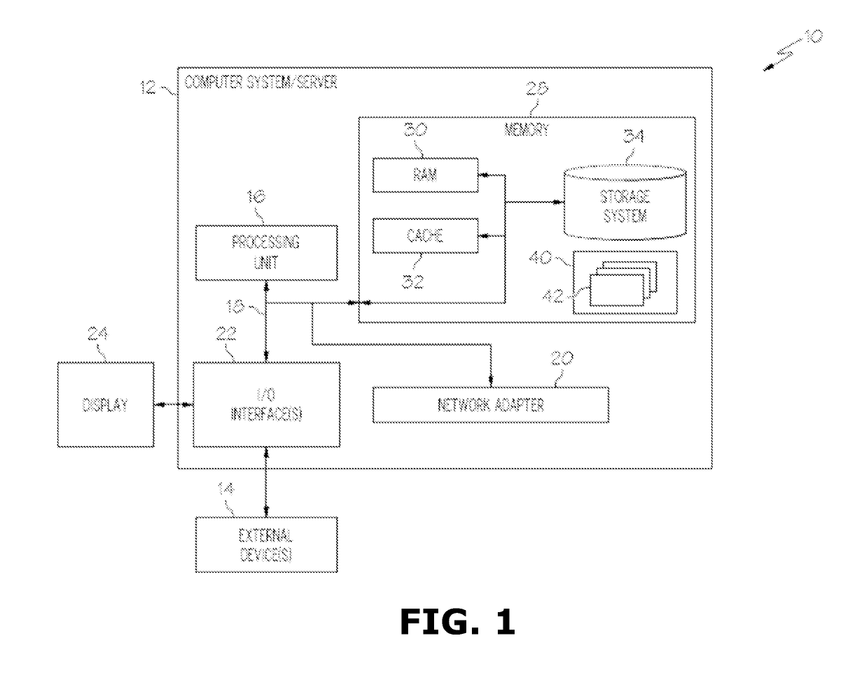

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In accordance with embodiments of the invention, computing node 10 may not necessarily even be part of a cloud network but instead could be part of another type of distributed or other network, or could represent a stand-alone node. For the purposes of discussion and illustration, however, node 10 is variously referred to herein as a “cloud computing node”.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, at least one processor or processing unit 16, a system memory 28, and a bus 18 that couples various system components including system memory 28 to processor 16.

Bus 18 represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by at least one data media interface. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, at least one application program, other program modules, and program data. Each of the operating system, at least one application program, other program modules, and program data or some combination thereof, may include an implementation of a networking environment. Program modules 42 generally carry out the functions and/or methodologies of embodiments of the invention as described herein.

Computer system/server 12 may also communicate with at least one external device 14 such as a keyboard, a pointing device, a display 24, etc.; at least one device that enable a user to interact with computer system/server 12; and/or any devices (e.g., network card, modem, etc.) that enable computer system/server 12 to communicate with at least one other computing device. Such communication can occur via I/O interfaces 22. Still yet, computer system/server 12 can communicate with at least one network such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

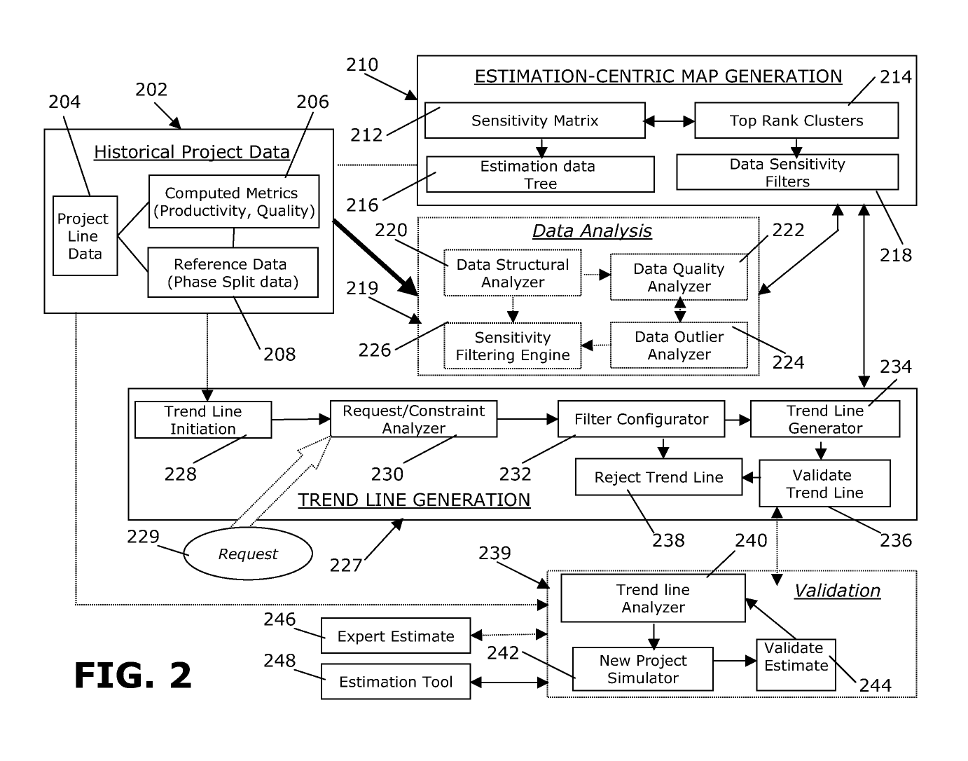

The disclosure now turns to FIG. 2. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIG. 2 can be performed or utilized by way of a processing unit or units and system memory such as those indicated, respectively, at 16 and 28 in FIG. 1, whether on a server computer, a client computer, a node computer in a distributed network, or any combination thereof

Broadly contemplated herein, in accordance with at least one embodiment of the invention, are methods and arrangements for the automated population of data estimation trend lines from historical project data. This can be undertaken via constraint-guided generation of estimation modeling, wherein data characteristics with estimation factors are mapped.

Shown in FIG. 2 is an arrangement for executing predictive analytics, in accordance with at least one embodiment of the invention. Historical project data 202 are available, which includes project line data 204, computed metrics 206 (e.g., relating to productivity and quality) and reference data 208 (e.g., including phase split data).

Generally, historical project data 202 essentially include, but are not limited to, information such as sizing, effort and scheduling, particularly as measured and planned with relation to executing a project. Metrics 206 can involve those data that are computed based on currently available data, such as a productivity measurement (e.g., which can be computed based on project size, time and effort, etc.). Reference data 208 can include data needed for better understanding a project. (e.g., data relating to the type of project, such as “minor enhancement”, “new development”, etc.) Reference data can also include phase definitions involved in a project.

In a manner to be better understood and appreciated herebelow, generation of an estimation-centric map (210), in accordance with at least one embodiment of the invention, involves assimilating the historical project data 202 and providing therefor a multi-dimensional data structure that supports evolving data in accordance with the size and characteristics of the data. Particularly, the map so generated serves to provide insights, that are ready to view and analyze, on the estimation-centric characteristics of data at multiple levels (by way of multi dimensional cluster wise segmentation), on various dependent/independent variables (e.g., effort and size), and associated metrics (e.g., effect density, productivity). Further, the map contains a specific range of outliers across multiple clusters as well as a sensitivity matrix that assesses data based on relevance of the data and on impact of the data. This stands in stark contrast to a conventional practice of a static and predefined expectation of data.

Essentially, in accordance with at least one embodiment of the invention, once outliers are identified based on an evaluation of data against specific dimensions, the estimation-centric map 210 can then be refined after separation of these outliers from the associated data set, and then can identify currently applicable sensitivity matrices and associated filters, which helps in increased accuracy in estimation. For example, if there is a project with very high productivity and is the only minor enhancement type project with a low defect ratio, the removal of this as an outlier can now redefines the filters based on project type as well as validating the sensitivity aspects of defect ratio with respect to size.

In accordance with an estimation map generation process, in accordance with at least one embodiment of the invention, an incoming historical data structure 202 is analyzed (219). A data structural analyzer 220 and available data 202 are analyzed by a data structural analyzer 220, which transforms the data into a uniform structure. Essentially, the expected set of data along with the associated format in which the data are expected to be made available, is a standard uniform structure and can be also specific to a specific estimation tool. In this way, it is possible to carry out the conversion of data available from any source and in any format into such a uniform structure. This can be done manually (for smaller data sizes and/or if a one-time transformation of data is involved) or, if this data transformation exercise is expected to repeat (e.g., on a periodic basis), then parsing and transformation rules can be written and implemented.

In accordance with at least one embodiment of the invention, quality analysis (222) then assesses data completeness (e.g., by way of value insights), along with estimation readiness (e.g., by way of process insights), and missing data insights. This assists in judging an overall quality analysis for available data, by way of reducing the incoming data set on a basis of quality aspects.

Next, in accordance with at least one embodiment of the invention, direct outliers and metrics based outliers are computed on the basis of constraints and requirements that may be present (224). Another data analysis and preparation step is then undertaken towards completing the filter definitions, based on quality, outliers, data structure and data (226).

In accordance with at least one embodiment of the invention, this completes the data analysis/preparation process 219 that assists in the creation of an estimation-centric map. To complete the estimation-centric map generation process (210), a sensitivity matrix structure is created (212) along with top-relevant data clusters (214). From these, respectively, an estimation data tree structure is created (216), as well as data sensitivity filters (218). Clusters 214 are defined on a context-centric basis and ranked, based particularly on similarity and data impact. Essentially, for any specific cluster of data, which itself can be thought of as a subset of overall data, one can compute the predictability aspects of the data based on specific dimensional pairs and the associated correlation. The ranking then can be based on the number of projects in each of those clusters and the predictability value of the data in the clusters. The higher the predictability value, then the higher ranking of the cluster. Filters 218, for their part, are reusable and configurable filters for dynamic trend line generation.

By way of brief elaboration, in accordance with at least one embodiment of the invention, the sensitivity matrix 212 involves a collection of data variables classified as dependent and independent variables. While, conventionally, there is usually a pre-conceived (and even prejudicial) notion of sensitivity aspects between the dependent and independent variables, here this notion is challenged by actual analysis of data towards two ends. First, the actual set of dependent and independent variables are identified based on the data structure. Secondly, a subsequent analysis of each pair of one dependent variable and one independent variable on the whole data set, or for specific clusters of data, helps in revising the sensitivity matrix along with identifying the specific filters with respect to the data fields that have an impact on the associated data clusters.

Next is a dynamic trend line generation process 219, in accordance with at least one embodiment of the invention. A request 229 for trend line generation is received, which may include a specific context (e.g., new development, “Java” development, etc.), along with constraints for trend line creation (e.g., “Above 1 KLOC”, “1 PM”, “25 data sets”). A current state of the historical project data 202 then constitutes what is used for trend line initiation (228) and subsequent generation. While accumulated historical to-data data can be input at this point, it is also possible to input previous time windows of data. In other words, one can consider fully baselined data of completed projects (as opposed to current, in-process projects) that have been collected in previous time windows.)

In accordance with at least one embodiment of the invention, the request 229 is then objectively analyzed, and relevant filters are computed based on the context and constraints (232). As such, for a given project estimation requirement along with its context (e.g., type of project, language, industry, etc.) and constraints (e.g., schedule, effort, staffing), the corresponding applicable filters can be identified to satisfy the requirement. If filters are not sufficiently available, then the request is rejected (238). Otherwise, the filters are associated with the trend line request and the final set of selected filters for a given trendline generation is persisted or retained along with the generated trendline itself for future consideration or use, and can also be used for validating or auditing purposes with respect to cross-checking of the estimations thereby derived.

Next, in accordance with at least one embodiment of the invention, the filters (232) are instantiated on the estimation data model, or map. The data subset is retrieved and trend line generation for the request commences automatically (234). In a validation step 236, initial validation is performed based on a size constraint, followed by optional validation based on simulated estimation and acceptance or rejection of the trend line. The trend line is persisted, context is requested and validation results are provided; in other words, based on a request context and the generated trendline subject to passing the validation tests, the trendline can be persisted along with the validation results for future considerations.

In accordance with at least one embodiment of the invention, validation, or simulated estimation 236, involves retrieval and analysis (240) of the generated trendline. A randomly identified candidate project list is defined based on this step, and iterative estimation is initiated by hiding the actual data (242). An optional step of cross-validation with expert (i.e., qualitative) estimation may then be undertaken (246). On this basis, a generated trend line may also be rejected. Finally, the estimation error is validated with respect to actual data (244) and a report on the trend line is sent back to the map generation arrangement 210 and trend line generation arrangement 227.

In accordance with at least one embodiment of the invention, a dynamically created trend line is incorporated or “plugged in” to essentially any suitable estimation tool, including a conventional estimation tool 248 (e.g., the “SLIM” estimation tool developed by QSM, Inc. of McLean, Va.) for further processing. This represents a significant departure from employing what amounts to a static and often inaccurate trendline in an estimation tool.

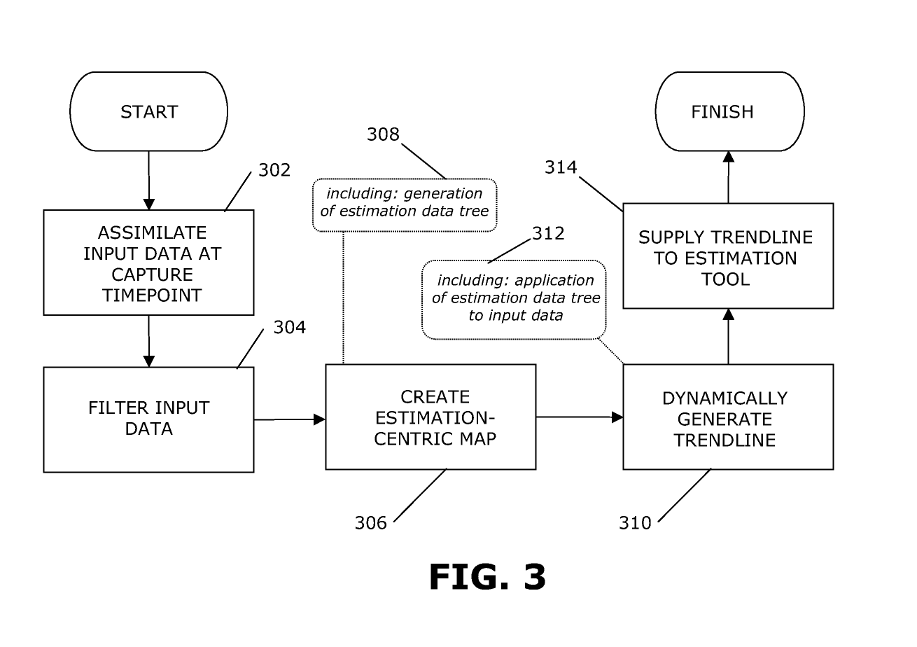

FIG. 3 sets forth a process more generally for dynamic trendline generation, in accordance with at least one embodiment of the invention. It should be appreciated that a process such as that broadly illustrated in FIG. 3 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 3 can be performed by way a processing unit or units and system memory such as those indicated, respectively, at 16 and 28 in FIG. 1.

As shown in FIG. 3, input data are assimilated at a capture timepoint from an estimation tool (302). The input data are filtered (304), and an estimation-centric map is created from the filtered data (306); this creating of a map includes generating an estimation data tree (308). A trendline is dynamically generated responsive to a request (310), wherein this generating of a trendline includes applying the estimation data tree to the input data (312). The dynamically generated trendline is supplied to the estimation tool (314).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
assimilating input data at a capture timepoint from an estimation tool;
filtering the input data;
creating an estimation-centric map from the filtered data;
said creating comprising generating an estimation data tree;
dynamically generating a trendline responsive to a request;
said generating comprising applying the estimation data tree to the input data; and
supplying the dynamically generated trendline to the estimation tool.

2. The method according to claim 1, wherein said creating comprises creating and ranking data clusters from the input data.

3. The method according to claim 2, wherein said creating of an estimation-centric map further comprises creating data sensitivity filters.

4. The method according to claim 1, wherein said filtering comprises assessing data structure integrity.

5. The method according to claim 1, wherein said filtering comprises assessing data quality.

6. The method according to claim 1, wherein said filtering comprises performing a data outlier analysis.

7. The method according to claim 1, wherein said creating comprises building a sensitivity matrix and employing the sensitivity matrix in generating the estimation data tree.

8. The method according to claim 1, further comprising rejecting the generated trend line responsive to a filtering condition.

9. The method according to claim 8, wherein said rejecting comprises rejecting the generated trend line responsive to a lack of data filters.

10. The method according to claim 1, further comprising validating the generated trendline.

11. The method according to claim 10, wherein said validating comprises applying the generated trendline to a hypothetical estimation scenario.

12. The method according to claim 10, wherein said validating comprises availing the generated trendline for subjective review.

13. An apparatus comprising:
at least one processor; and
a computer readable storage medium having computer readable program code embodied therewith and executable by the at least one processor, the computer readable program code comprising:
computer readable program code configured to assimilate input data at a capture timepoint from an estimation tool;
computer readable program code configured to filter the input data;
computer readable program code configured to create an estimation-centric map from the filtered data;
computer readable program code configured to generate an estimation data tree;
computer readable program code configured to dynamically generate a trendline responsive to a request;
computer readable program code configured to apply the estimation data tree to the input data; and
computer readable program code configured to supply the dynamically generated trendline to the estimation tool.

14. A computer program product comprising:
a computer readable storage medium having computer readable program code embodied therewith, the computer readable program code comprising:
computer readable program code configured to assimilate input data at a capture timepoint from an estimation tool;
computer readable program code configured to filter the input data;
computer readable program code configured to create an estimation-centric map from the filtered data;
computer readable program code configured to generate an estimation data tree;
computer readable program code configured to dynamically generate a trendline responsive to a request;
computer readable program code configured to apply the estimation data tree to the input data; and
computer readable program code configured to supply the dynamically generated trendline to the estimation tool.

15. The computer program product according to claim 14, wherein said computer readable program code is configured to create and rank data clusters from the input data.

16. The computer program product according to claim 15, wherein said computer readable program code is is configured to create data sensitivity filters.

17. The computer program product according to claim 14, wherein said computer readable program code is configured to assess input data structure integrity.

18. The computer program product according to claim 14, wherein said computer readable program code is configured to assess input data quality.

19. The computer program product according to claim 14, wherein said computer readable program code is configured to perform a data outlier analysis.

20. The computer program product according to claim 14, wherein said computer readable program code is configured to build a sensitivity matrix and employ the sensitivity matrix in generating the estimation data tree.

21. The computer program product according to claim 14, wherein said computer readable program code is further configured to reject the generated trend line responsive to a filtering condition.

22. The computer program product according to claim 21, wherein said computer readable program code is configured to reject the generated trend line responsive to a lack of data filters.

23. The computer program product according to claim 14, said computer readable program code is further configured to validate the generated trendline.

24. The computer program product according to claim 23, wherein said computer readable program code is configured to apply the generated trendline to a hypothetical estimation scenario.

25. The computer program product according to claim 23, wherein said computer readable program code is configured avail the generated trendline for subjective review.
